(19) United States
(12) Patent Application Publication
(10) Pub. No.: US 2019/0087333 A1
(43) Pub. Date: Mar. 21, 2019

(54) CONVERTING A STALE CACHE MEMORY UNIQUE REQUEST TO A READ UNIQUE SNOOP RESPONSE IN A MULTIPLE (MULTI-) CENTRAL PROCESSING UNIT (CPU) PROCESSOR TO REDUCE LATENCY ASSOCIATED WITH REISSUING THE STALE UNIQUE REQUEST

(71) Applicant: QUALCOMM Incorporated, San Diego, CA (US)

(72) Inventors: Eric Francis Robinson, Raleigh, NC (US); Thomas Philip Speier, Wake Forest, NC (US); Joseph Gerald McDonald, Raleigh, NC (US); Garrett Michael Drapala, Cary, NC (US); Kevin Neal Magill, Durham, NC (US)

(21) Appl. No.: 16/129,451

(22) Filed: Sep. 12, 2018

Related U.S. Application Data
(60) Provisional application No. 62/559,146, filed on Sep. 15, 2017.

(51) Int. Cl. G06F 12/0815; G06F 13/40; G06F 13/16

(52) U.S. Cl. CPC G06F 12/0815; G06F 2212/1021; G06F 13/1668; G06F 13/4027

(57) ABSTRACT

Converting a stale cache memory unique request to a read unique snoop response in a multiple (multi-) central processing unit (CPU) processor is disclosed. The multi-CPU processor includes a plurality of CPUs that each have access to either private or shared cache memories in a cache memory system. Multiple CPUs issuing unique requests to write data to a same coherence granule in a cache memory causes one unique request for a requested CPU to be serviced or “win” to allow that CPU to obtain the coherence granule in a unique state, while the other unsuccessful unique requests become stale. To avoid retried unique requests being reordered behind other pending, younger requests which would lead to lack of forward progress due to starvation or livelock, the snooped stale unique requests are converted to read unique snoop responses so that their request order can be maintained in the cache memory system.

### PRIORITY

The present application claims priority under 35 U.S.C. § 119(e) to U.S. Provisional Patent Application Ser. No. 62/559,146 filed on Sep. 15, 2017 and entitled “CONVERTING A STALE CACHE MEMORY UNIQUE REQUEST TO A READ UNIQUE SNOOP RESPONSE IN A MULTIPLE (MULTI-) CENTRAL PROCESSING UNIT (CPU) PROCESSOR TO REDUCE LATENCY ASSOCIATED WITH REISSUING THE STALE UNIQUE REQUEST,” the contents of which is incorporated herein by reference in its entirety.

### BACKGROUND

### I. Field of the Disclosure

The technology of the disclosure relates generally to cache memories in a multiple (multi-) central processing unit (CPU) processor-based system, and more particularly to maintaining coherence among different cache memories in the processor-based system.

### II. Background

Microprocessors perform computational tasks in a wide variety of applications. A conventional microprocessor includes one or more central processing units (CPUs). Multiple (multi)-processor systems that employ multiple CPUs, such as dual processors or quad processors for example, provide faster throughput execution of instructions and operations. The CPU(s) execute software instructions that instruct a processor to fetch data from a location in memory, and perform one or more processor operations using the fetched data. The result may then be stored in memory. As examples, this memory can be a cache memory local to the CPU, a shared local cache among CPUs in a CPU block, a shared cache among multiple CPU blocks, or main memory of a microprocessor. Cache memory, which can also be referred to as just “cache,” is a smaller, faster memory that stores copies of data stored at frequently accessed memory addresses in main memory or higher level cache memory to reduce memory access latency. Thus, a cache memory can be used by a CPU to reduce memory access times.

For example, FIG. 1A illustrates an example of a processor-based system 100 that includes a multi-CPU processor 102 that includes multiple CPUs 104(0)-104(N) and a hierarchical memory system. As part of the hierarchical memory system, as an example, CPU 104(0) includes a private local cache memory 106, which may be a Level 2 (L2) cache memory. CPUs 104(1), 104(2) and CPUs 104(N−1), CPU 104(N) are configured to interface with respective local shared cache memories 106S(0)-106S(X), which may also be L2 cache memories for example. If a data read request requested by a CPU 104(0)-104(N) results in a cache miss to the respective cache memories 106, 106S(0)-106S(X), the read request may be communicated to a next level cache memory, which in this example is a shared cache memory 108. The shared cache memory 108 may be a Level 3 (L3) cache memory as an example. The cache memory 106, the local shared cache memories 106S(0)-106S(X), and the shared cache memory 108 are part of a cache memory system 110. An internal interconnect bus 112, which may be a coherent bus, is provided that allows each of the CPUs 104(0)-104(N) to access the shared cache memories 106S(0)-106S(X) (if shared to the CPU 104(0)-104(N)), the shared cache memory 108, and other shared resources coupled to the interconnect bus 112. A snoop controller 114 is also coupled to the interconnect bus 112. The snoop controller 112 is a circuit that monitors or snoops cache memory bus transactions on the interconnect bus 112 to maintain cache coherency among the cache memories 106, 106S(0)-106S(X), 108 in the cache memory system 110. Other shared resources that can be accessed by the CPUs 104(0)-104(N) through the interconnect bus 112 can include input/output (I/O) devices 116 and a system memory 118 (e.g., a dynamic random access memory (DRAM)). If a cache miss occurs for a read request issued by a CPU 104(0)-104(N) in each level of the cache memories 106, 106S(0)-106S(X), 108 accessible for the CPU 104(0)-104(N), the read request is serviced by the system memory 118 and the data associated with the read request is installed in the cache memories 106, 106S(0)-106S(X), 108 associated with the requested CPU 104(0)-104(N).

Thus, the multi-CPU processor 102 in FIG. 1A is a coherent multi-CPU processor 102 in that cache coherency is maintained in the cache memory system 110. When data is accessed in the cache memory system 110, the data is accessed at a granularity of a coherence granule, which refers to a data block size (e.g., 64 bytes, 128 bytes) that the multi-CPU processor 102 uses to manage cache coherency. For example, it's common for cache memories to set their cache line size equal to a coherence granule of the cache memory system 110. It is common for there to exist multiple copies of the same coherence granule concurrently in various cache memories in the cache memory system 110. This enables better performance by allowing each CPU 104(0)-104(N) (or group of CPUs 104(0)-104(N)) to save a copy of the shared coherence granule in a local cache memory 106, 106S(0)-106S(X) that may be accessed more quickly. Each coherence granule in a cache memory in the cache memory system 110 maintains a coherence granule state that indicates whether it is safe to modify the data contents of the coherence granule. The basic cache states for a coherence granule are “unique,” meaning no other cache memory in the cache memory system 110 contains a valid form of the data associated with the coherence granule, “shared,” meaning another cache memory in the cache memory system 110 contains a valid form of the data, and “invalid,” meaning that the data associated with the coherence granule is not valid. For example, the term “unique” may be synonymous with the “exclusive” state of the well-known MESI protocol that may be executed by the snoop controller 114 for maintaining coherence. When a cache memory in the cache memory system 110 does not hold a coherence granule in a unique cache state, there may be other cache memories in the cache memory system 110 that also hold a copy of the coherence granule. Therefore, it's not safe to modify the data contents of that coherence granule unless the other cache memories are able to observe that modification.

Suppose the coherence granule size in the cache memory system 110 in the multi-CPU processor 102 in FIG. 1A was 128 bytes, and that CPU 104(0), acting as a master CPU, wanted to write eight (8) bytes within a particular coherence granule A, but the master CPU 104(0) does not currently have coherence granule A in its cache memory 106. Thus, master CPU 104(0) will want to install coherence granule A in its cache memory 106. The CPU 104(0), acting as a master CPU, would typically make a read unique request to the interconnect bus 112 asking for unique access to coherence granule A and for a copy of the data for coherence granule A. Even though master CPU 104(0) only wants to write eight (8) bytes of the coherence granule A that is installed, the entire data of the coherence granule is installed in the coherence granule A for coherence purposes. The read unique request issued by master CPU 104(0) would cause a snoop request to be generated by the snoop controller 114 to any other cache memories in the cache memory system 110 that may hold a copy of coherence granule A. The snoop request lets the other cache memories as “snoopers” know that master CPU 104(0) is in the process of obtaining a unique copy of coherence granule A. Some coherent cache memory systems enable snoopers to provide the read data directly to the master of the request, which is referred to as read data intervention or snoop intervention. Once the master CPU 104(0) completes the request and it obtains the read data, it's free to perform the eight (8) byte write to coherence granule A installed in its cache memory 106. If any other CPU 104(1)-104(N) later wants to cache a copy of coherence granule A, it would need to obtain the data from master CPU 104(0), because master CPU 104(0) holds the most up-to-date copy of coherence granule A.

With continuing reference to FIG. 1, in another example, suppose that master CPU 104(0) held a copy of coherence granule A in its cache memory 106 and that the cache state of coherence granule A was “shared.” In this case, the master CPU 104(0) does not need to read coherence granule A, because it already holds a copy of the data for coherence granule A. However, because the coherence granule state for coherence granule A is shared, there may be other cache memories in the cache memory system 110 that also hold a copy of coherence granule A. Before master CPU 104(0) updates its copy of coherence granule A, the master CPU 104(0) must ensure that only cache memory 106 holds a copy of coherence granule A so that cache coherency is maintained. If cache coherency is lost, then other cache memories in the cache memory system 110 may not be able to observe the write operation performed by master CPU 104(0) for coherence granule A. In this case, because master CPU 104(0) does not need to obtain a copy of the data, it does not make a read unique request, but instead makes an upgrade unique request on the interconnect bus 112. The upgrade unique request lets the snoopers know that master CPU 104(0) is obtaining a unique copy of coherence granule A and that master CPU 104(0) already has a copy of the data for coherence granule A.

With continuing reference to this example, suppose that both CPUs 104(0), 104(N) acting as master CPUs, each hold a shared copy of coherence granule A and both CPUs 104(0), 104(N) attempt to write to the coherence granule A in their respective cache memories 106, 106S(X) at the same time. Neither CPU 104(0), 104(N) is permitted to write data to the coherence granule A until it holds the coherence granule A in its cache memory 106, 106S(X) in a unique cache state. Thus, for each CPU 104(0), 104(N) to write data to coherence granule A in a shared cache state, each CPU 104(0), 104(N) would issue an upgrade unique request for coherence granule A on the interconnect bus 112. This is shown by example in FIG. 1B. As shown therein, both CPU 104(0) and CPU 104(N) issue upgrade unique requests 120(0), 120(N) to the interconnect bus 112 that are received by the snoop controller 114. Suppose that the upgrade unique request 120(N) by CPU 104(N) is first to be serviced by the snoop controller 114. Thus, upgrade unique request 120(N) by CPU 104(N) for coherence granule A causes the snoop controller 114 to issue a snoop kill 122(N) to the cache memory 106 of CPU 104(0), which causes CPU 104(0) to kill (i.e., invalidate) its copy of coherence granule A in the cache memory 106. CPU 104(N) then upgrades its cache state for coherence granule A to unique and is permitted to perform its write operation for coherence granule A. Next, the upgrade unique request 120(0) by CPU 104(0) is serviced by the cache memory system 110. However, CPU 104(0)'s copy of coherence granule A in its cache memory 106 has been invalidated as a result of the upgrade unique request 120(0) issued by CPU 104(0). This means that the cache memory 106 for CPU 104(0) no longer holds a coherent copy of the data for coherence granule A. Thus, the upgrade unique request 120(0) by CPU 104(0) cannot be permitted to cause the snoop controller 114 to issue a snoop kill 122(0) to the coherence granule A in CPU 104(N) in a unique cache state, because CPU 104(0) does not have a copy of the data for coherence granule A in CPU 104(N). Otherwise, coherence for coherence granule A would be lost.

One solution to this problem is to provide for the snoop controller 114 in the cache memory system 110 to prevent the upgrade unique request 120(0) issued by CPU 104(0) from killing other snooper CPU 104(1)-104(N) copies of coherence granule A, because the cache memory 106 for CPU 104(0) has lost its copy of coherence granule A. CPU 104(N) could cause the upgrade unique request 120(0) issued by CPU 104(0) to be retried since CPU 104(N) knows that it is not possible for CPU 104(0) to have a shared copy of the data for coherence granule A. Alternatively, the snoop controller 114 could include a filter that intercepts the snoop request resulting from the upgrade unique request 120(0) issued by CPU 104(0) before being sent to CPU 104(N). This would cause the CPU 104(0) issuing the upgrade unique request 120(0) to be given a retry result, such that CPU 104(0) issues a retry of the upgrade unique request 120(0) as a read unique request. The read unique request issued by CPU 104(0) would arrive at CPU 104(1) as a read unique snoop, in which case CPU 104(N) would send a copy of the coherence granule A to CPU 104(0) and invalidate its local copy. Thus, CPU 104(0) would become responsible for updating the system memory 118 for both its own write operation and for CPU 104(N)'s previous write operation to coherence granule A.

Retrying a stale cache memory unique request resulting in the retried request being reordered behind other pending, younger requests by the snoop controller 114 can lead to lack of forward progress due to starvation or livelock. Performance is lost due to the extra time needed to send the result all the way back to the CPU 104(0) before it can get started on its resend of the bus request as a read unique request.

### SUMMARY OF THE DISCLOSURE

Aspects disclosed herein include converting a stale cache memory unique request to a read unique snoop response in a multiple (multi-) central processing unit (CPU) processor. This can reduce latency associated with reissuing the stale cache memory unique request. In aspects disclosed herein, the multi-CPU processor includes a plurality of CPUs interconnected to an interconnect bus. The CPUs have access to either private or shared cache memories in a cache memory system. To maintain data coherency among the cache memories in the cache memory system, when a requesting CPU wants to write data associated with a given coherence granule (e.g., a cache line) to its cache memory that is not already in a unique cache state, the requesting CPU acting as a master CPU issues a unique request over the interconnect bus to put the coherence granule to be written in a unique (i.e., exclusive) cache state. In this manner, no other CPU can read or write data to the coherence granule during the write operation. Also, if the CPU does not have a shared copy of coherence granule A, the unique request issued by the requesting CPU also includes a request to obtain the data for the coherence granule from another cache memory or from system memory. Multiple CPUs issuing unique requests to write data to the same coherence granule in a cache memory causes one unique request for a requested CPU to be serviced or “win” to allow that CPU to obtain the coherence granule in a unique state, while the other unsuccessful unique requests may become stale. Stale unique requests can be retried to allow these other CPUs to also perform their write operations behind the CPU that previously won the unique request. Thus, in aspects disclosed herein, to avoid the retried unique requests being reordered behind other pending, younger requests which would lead to lack of forward progress due to starvation or livelock, unique requests that become stale are converted to read unique snoop responses so that their request order can be maintained in the cache memory system. For example, the multi-CPU processor may include a snoop controller that manages coherency and maintains an ordered queue of requests from which to issue snoop requests over the interconnect bus to be snooped by the other CPUs.

In another exemplary aspect, the requesting CPU whose unique request won and was serviced with the data for the coherence granule in a unique cache state to be written can act as a snooper CPU and snoop the in-flight unique requests from another CPU(s) for the same coherence granule. Thus, the requesting CPU that received the data in the unique cache state knows that the other CPU(s) that issued the in-flight unique requests for the same coherence granule will eventually request the data for the coherence granule in a unique state to then carry out their write operations. The requesting CPU that received the data in the unique cache state can behave as if a read unique request was received from the other CPU(s) and indicate a willingness to send the data after written to the interconnect bus to reduce the latency involved with servicing future read unique requests. Further, because the requesting CPU that received the data in a unique state could have had its cache state for the data downgraded to a shared cache state by the time the in-flight unique request for the same coherence granule is received, CPUs that hold a copy of the coherence granule in a shared state may also indicate a willingness to send the data.

In yet another exemplary aspect, the requesting CPU whose unique request won and was serviced with the data for the coherence granule in a unique cache state to be written can act as a snooper CPU to snoop the in-flight unique requests from another CPU(s) for the same coherence granule. Thus, the requesting CPU that received the data in the unique cache state knows that the other CPU(s) that issued the in-flight unique requests for the same coherence granule will eventually request the data for the coherence granule in a unique state to then carry out their write operations. The requesting CPU that received the data in the unique cache state can go ahead and assume that the other CPU(s) will convert the failed unique request to a read unique snoop response and send the written data onto the interconnect bus to generate a snoop response in response to the converted read unique snoop response by the other CPU(s).

In yet another exemplary aspect, a snoop filter could be employed in the multi-CPU processor to avoid the need to intercept the other CPU(s) unique requests that will fail and not be valid to avoid the other CPU(s) unique requests from killing the other CPU(s)' copy of the data.

In exemplary aspects disclosed herein, a multi-CPU processor is provided. The multi-CPU processor comprises an interconnect bus, a snoop controller coupled to the interconnect bus, and a plurality of CPUs each communicatively coupled to the interconnect bus and each communicatively coupled to an associated cache memory. The multi-CPU processor also comprises a master CPU among the plurality of CPUs, which is configured to issue a unique request for a coherence granule on the interconnect bus to request a unique cache state for the coherence granule in its associated cache memory in response to a memory write operation comprising write data. The master CPU is also configured to receive a snoop request on the interconnect bus from the snoop controller in response to issuing the unique request, and determine that if the unique request issued on the interconnect bus became stale in response to another unique request issued by the master CPU among the plurality of CPUs for the coherence granule being assigned the unique cache state. The master CPU is further configured, in response to determining that the unique request issued on the interconnect bus became stale, to issue a snoop response on the interconnect bus to the snoop controller to convert the stale unique request to a read unique snoop response.

In this regard, in another exemplary aspect, a method of converting a stale cache memory upgrade unique request to a read unique snoop response in a multi-CPU processor, comprising a plurality of CPUs each communicatively coupled to an interconnect bus and each communicatively coupled to an associated cache memory, comprising a master CPU among the plurality of CPUs, is provided. The method comprises issuing a unique request for a coherence granule on the interconnect bus to request a unique cache state for the coherence granule in its associated cache memory in response to a memory write operation comprising write data. The method further comprises receiving a snoop request on the interconnect bus from a snoop controller in response to issuing the unique request. The method further comprises determining that the unique request issued on the interconnect bus became stale in response to another unique request issued by the master CPU among the plurality of CPUs for the coherence granule being assigned the unique cache state. The method also comprises, in response to determining that the unique request issued on the interconnect bus became stale, issuing a snoop response on the interconnect bus to the snoop controller to convert the stale unique request to a read unique snoop response.

### BRIEF DESCRIPTION OF THE FIGURES

FIG. 1A is a block diagram of an exemplary processor-based system that includes a plurality of central processing units (CPUs) and a memory system that includes a cache memory system including a hierarchy of local and shared cache memories and a system memory;

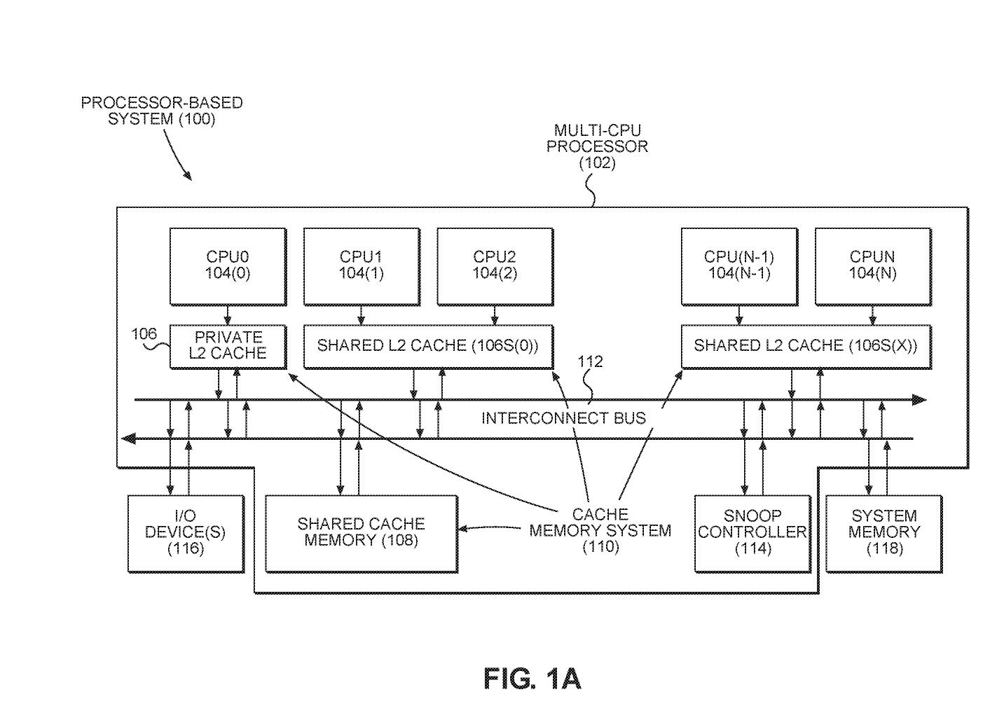

FIG. 1B is a block diagram illustrating two CPUs in the processor-based system in FIG. 1A both issuing upgrade unique requests to the same coherence granule to prepare for a write operation to the coherence granule;

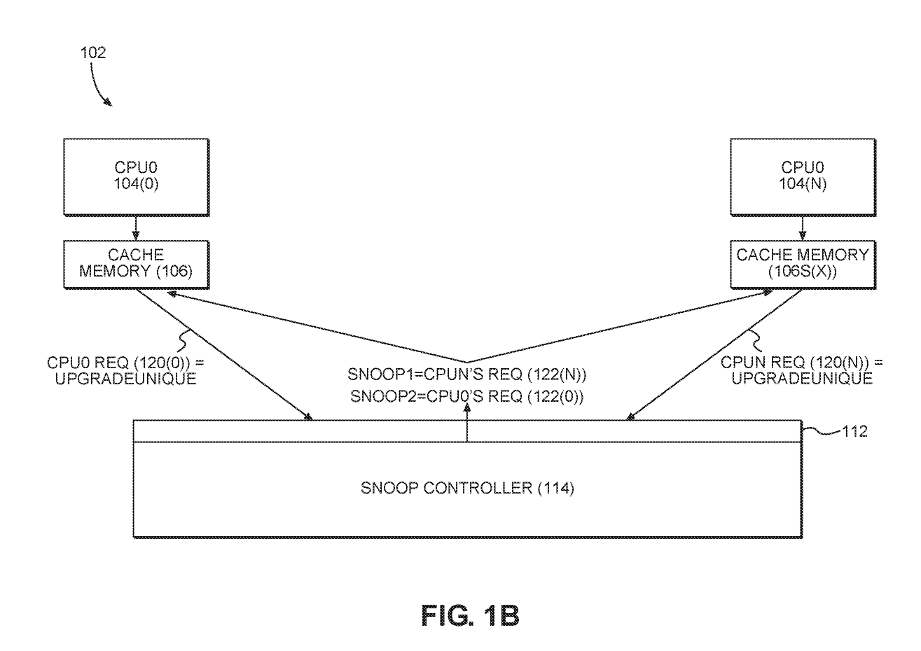

FIG. 2 is a block diagram of an exemplary processor-based system that includes a plurality of CPUs and a memory system that includes a system memory, wherein the CPUs are configured to convert stale cache memory upgrade unique requests to read unique snoop responses to reduce latency with reissuing the stale cache memory unique requests;

FIG. 3A is a flowchart illustrating an exemplary process of a first CPU in the processor-based system in FIG. 2 acting as master CPU issuing an upgrade unique request on the interconnect bus for a write operation, and retrying the unique request that has become stale;

FIG. 3B is a flowchart illustrating an exemplary process of a second CPU acting as a snooper CPU in the processor-based system in FIG. 2 that holds a coherent form of data associated with the memory address associated with the stale cache memory unique request from the first CPU, snooping the unique request from the first CPU and sending the data associated with the retried unique request on the interconnect bus to be snooped by the first CPU;

FIG. 3C is a flowchart illustrating an exemplary process of the first CPU waiting for a snoop response in response to issuing a unique request issued in the exemplary process in FIG. 3A;

FIG. 3D is a flowchart illustrating an exemplary process of the snoop controller in the processor-based system in FIG. 2 receiving the cache memory unique request issued by the first CPU that becomes stale and filtering the request to determine which CPU should snoop the stale cache memory unique request;

FIG. 4A is a flowchart illustrating an exemplary process of a first CPU acting as a master CPU in the processor-based system in FIG. 2 issuing a unique request on the interconnect bus for a write operation, which then becomes stale, and waiting for read data provided by the second CPU without retrying the unique request in response to a snoop response for a snoop controller indicating the stale unique request was converted to a read unique request;

FIG. 4B is a flowchart illustrating an exemplary process of a second CPU acting as a snooper CPU in the processor-based system in FIG. 2 that holds a coherent form of data associated with the memory address associated with the stale unique request from the first CPU, snooping the upgrade unique request issued by the first CPU from the process in FIG. 4A, and sending a willingness indication to the interconnect bus indicating a willingness to supply the data to the first CPU in response to the second CPU holding the coherence granule as unique;

FIG. 4C is a flowchart illustrating an exemplary process of the first CPU waiting for a snoop response in response to issuing a unique request issued in the exemplary process in FIG. 4A;

FIG. 5 is a flowchart illustrating an alternative exemplary process of the snoop controller in the processor-based system in FIG. 2 determining the cache memory unique request issued by the first CPU becoming stale and automatically converting the stale cache memory unique request to a converted read unique request on the interconnect bus to be snooped by the second CPU without waiting for the first CPU to issue a converted read unique snoop response like provided in the exemplary process in FIG. 4C;

FIG. 6 is a flowchart illustrating an exemplary process of the snoop controller in the processor-based system in FIG. 2 determining the unique request issued by the first CPU becoming stale, and sending an upgrade unique request retry on the interconnect bus without a snoop request being generated to be snooped by the first CPU to generate a retried upgrade unique request; and

FIG. 7 is a block diagram of an exemplary processor-based system that includes a plurality of CPUs and a memory system that includes a system memory, wherein the CPUs are configured to convert stale cache memory upgrade unique requests to read unique snoop responses to reduce latency with reissuing the stale cache memory unique requests, according to any of the exemplary aspects disclosed herein.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include converting a stale cache memory unique request to a read unique snoop response in a multiple (multi-) central processing unit (CPU) processor. This can reduce latency associated with reissuing the stale cache memory unique request. In aspects disclosed herein, the multi-CPU processor includes a plurality of CPUs interconnected to an interconnect bus. The CPUs have access to either private or shared cache memories in a cache memory system. To maintain data coherency among the cache memories in the cache memory system, when a requesting CPU wants to write data associated with a given coherence granule (e.g., a cache line) to its cache memory that is not already in a unique cache state, the requesting CPU acting as a master CPU issues a unique request over the interconnect bus to put the coherence granule to be written in a unique (i.e., exclusive) cache state. In this manner, no other CPU can read or write data to the coherence granule during the write operation. Also, if the CPU does not have a shared copy of coherence granule A, the unique request issued by the requesting CPU also includes a request to obtain the data for the coherence granule from another cache memory or from system memory. Multiple CPUs issuing unique requests to write data to the same coherence granule in a cache memory causes one unique request for a requested CPU to be serviced or “win” to allow that CPU to obtain the coherence granule in a unique state, while the other unsuccessful unique requests may become stale. Stale unique requests can be retried to allow these other CPUs to also perform their write operations behind the CPU that previously won the unique request. Thus, in aspects disclosed herein, to avoid the retried unique requests being reordered behind other pending, younger requests which would lead to lack of forward progress due to starvation or livelock, unique requests that become stale are converted to read unique snoop responses so that their request order can be maintained in the cache memory system. For example, the multi-CPU processor may include a snoop controller that manages coherency and maintains an ordered queue of requests from which to issue snoop requests over the interconnect bus to be snooped by the other CPUs.

In another exemplary aspect, the requesting CPU whose unique request won and was serviced with the data for the coherence granule in a unique cache state to be written can act as a snooper CPU and snoop the in-flight unique requests from another CPU(s) for the same coherence granule. Thus, the requesting CPU that received the data in the unique cache state knows that the other CPU(s) that issued the in-flight unique requests for the same coherence granule will eventually request the data for the coherence granule in a unique state to then carry out their write operations. The requesting CPU that received the data in the unique cache state can behave as if a read unique request was received from the other CPU(s) and indicate a willingness to send the data after written to the interconnect bus to reduce the latency involved with servicing future read unique requests.

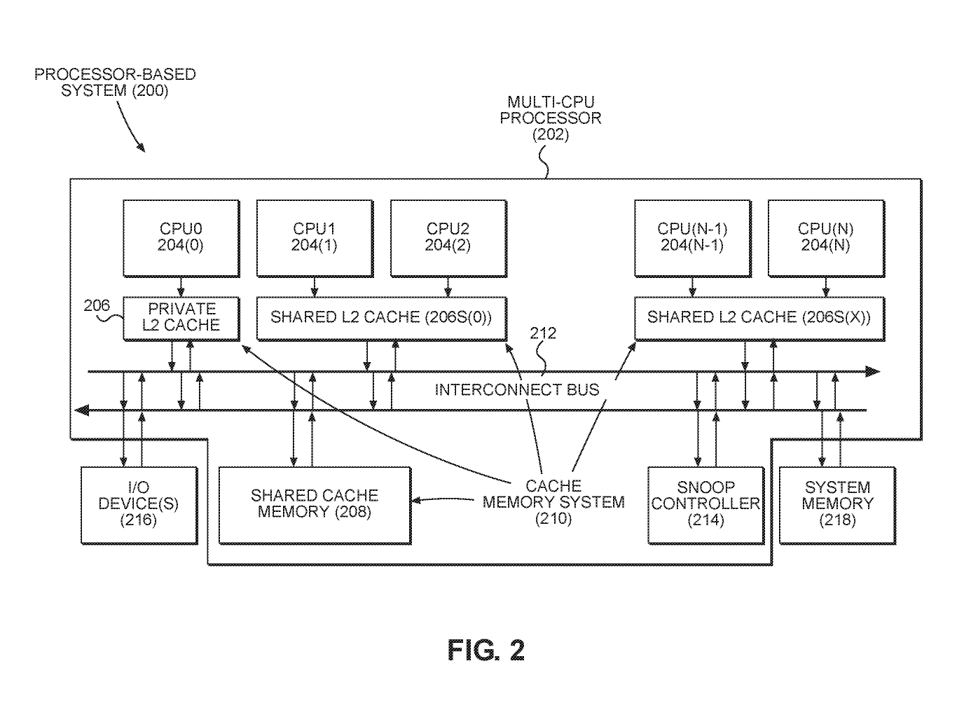

In this regard, FIG. 2 illustrates an example of a processor-based system 200 that includes a multi-CPU processor 202. As will be discussed in more detail below, the multi-CPU processor 202 includes multiple CPUs 204(0)-204(N) that are configured to convert a cache memory upgrade unique request that becomes stale to read unique snoop responses to reduce latency with reissuing the stale cache memory unique request. The multi-CPU processor 202 includes a hierarchical memory system. As part of the hierarchical memory system, as an example, CPU 204(0) includes a private local cache memory 206, which may be a Level 2 (L2) cache memory. CPUs 204(1), 204(2) and CPUs 204(N−1), CPU 204(N) are configured to interface with respective local shared cache memories 206S(0)-206S(X), which may also be L2 cache memories for example. If a data read request requested by a CPU 204(0)-204(N) results in a cache miss to the respective cache memories 206, 206S(0)-206S(X), the read request may be communicated to a next level cache memory, which in this example is a shared cache memory 208. The shared cache memory 208 may be a Level 3 (L3) cache memory as an example. The cache memory 206, the local shared cache memories 206S(0)-206S(X), and the shared cache memory 208 are part of a cache memory system 210. An internal interconnect bus 212, which may be a coherent bus, is provided that allows each of the CPUs 204(0)-204(N) to access the shared cache memories 206S(0)-206S(X) (if shared to the CPUs 204(0)-204(N)), the shared cache memory 208, and other shared resources coupled to the interconnect bus 212.

With continuing reference to FIG. 2, a snoop controller 214 is also coupled to the interconnect bus 212. The snoop controller 214 is a circuit that monitors or snoops the cache memory bus transactions on the interconnect bus 212 to maintain cache coherency among the cache memories 206, 206S(0)-206S(X), 208 in the cache memory system 210. Other shared resources that can be accessed by the CPUs 204(0)-204(N) through the interconnect bus 212 can include input/output (IO) devices 216 and a system memory 218 (e.g., a dynamic random access memory (DRAM)). If a cache miss occurs for a read request issued by a CPU 204(0)-204(N) in each level of the cache memories 206, 206S(0)-206S(X) accessible for the CPU 204(0)-204(N), the read request is serviced by the system memory 218 and the data associated with the read request is installed in the cache memories 206, 206S(0)-206S(X), 208 associated with the requested CPU 204(0)-204(N).

Thus, the multi-CPU processor 202 in FIG. 2 is a coherent multi-CPU processor 202 in that cache coherency is maintained in the cache memory system 210. When data is accessed in the cache memory system 210, the data is accessed at a granularity of a coherence granule, which refers to a data block size (e.g., 64 bytes, 128 bytes) that the multi-CPU processor 202 uses to manage cache coherency. For example, it's common for cache memories to set their cache line size equal to a coherence granule of the cache memory system 210. It is common for there to exist multiple copies of the same coherence granule concurrently in various cache memories in the cache memory system 210. This enables better performance by allowing each CPU 204(0)-204(N) (or group of CPUs 204(0)-204(N)) to save a copy of the shared coherence granule in a local cache memory 206, 206S(0)-206S(X) that may be accessed more quickly. Each coherence granule in a cache memory 206, 206S(0)-206S(X) in the cache memory system 210 maintains a coherence granule state that indicates whether it is safe to modify the data contents of the coherence granule. The basic cache states for a coherence granule are “unique,” meaning no other cache memory in the cache memory system 210 contains a valid form of the data associated with the coherence granule, “shared,” meaning another cache memory in the cache memory system 210 contains a valid form of the data, and “invalid,” meaning that the data associated with the coherence granule is not valid. For example, the term “unique” may be synonymous with the “exclusive” state of the well-known MESI protocol that may be executed by the snoop controller 214 for maintaining coherence. When a cache memory 206, 206S(1)-206S(X) in the cache memory system 210 does not hold a coherence granule in a unique cache state, there may be other cache memories in the cache memory system 210 that also hold a copy of the coherence granule. Therefore, it's not safe to modify the data contents of that coherence granule unless the other cache memories are able to observe that modification.

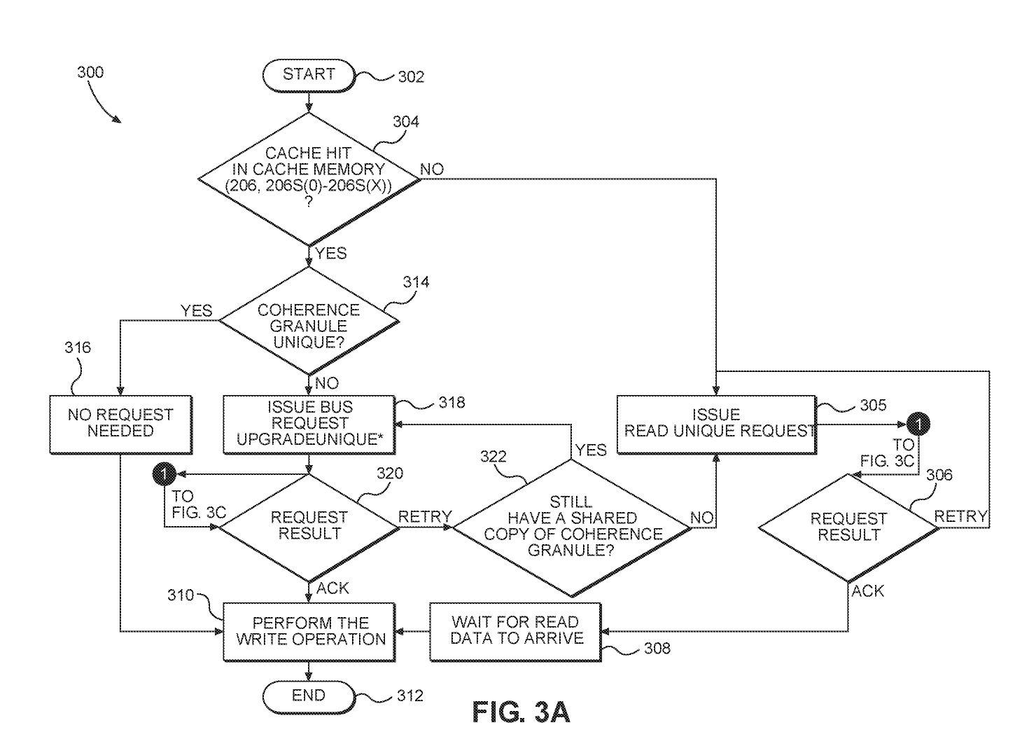

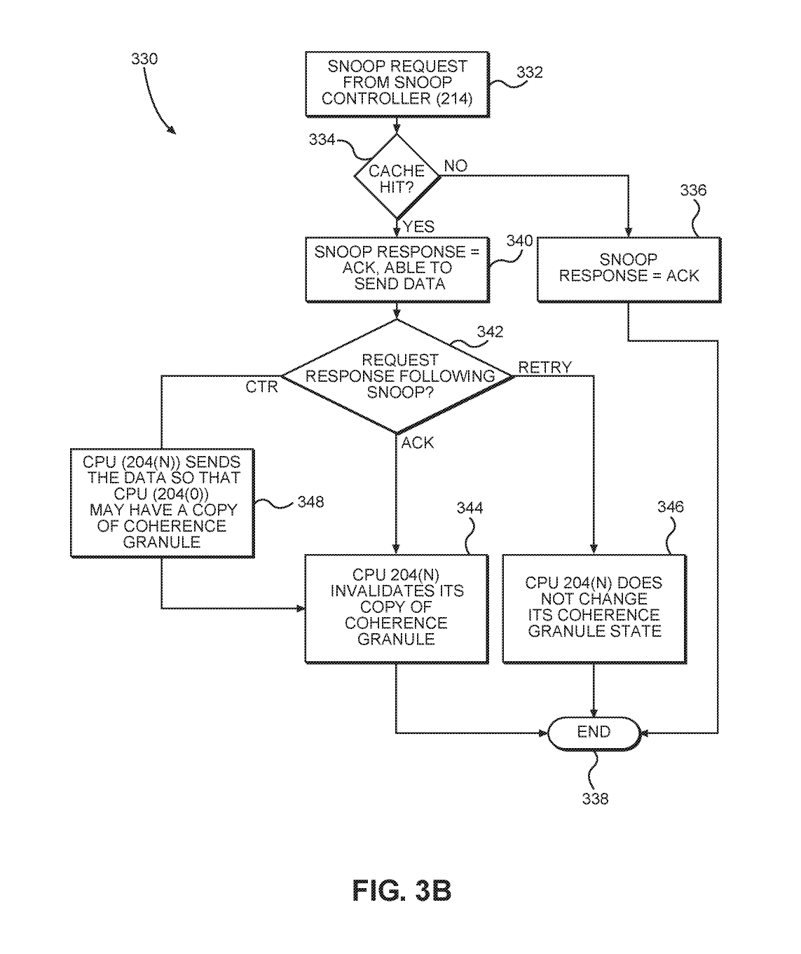

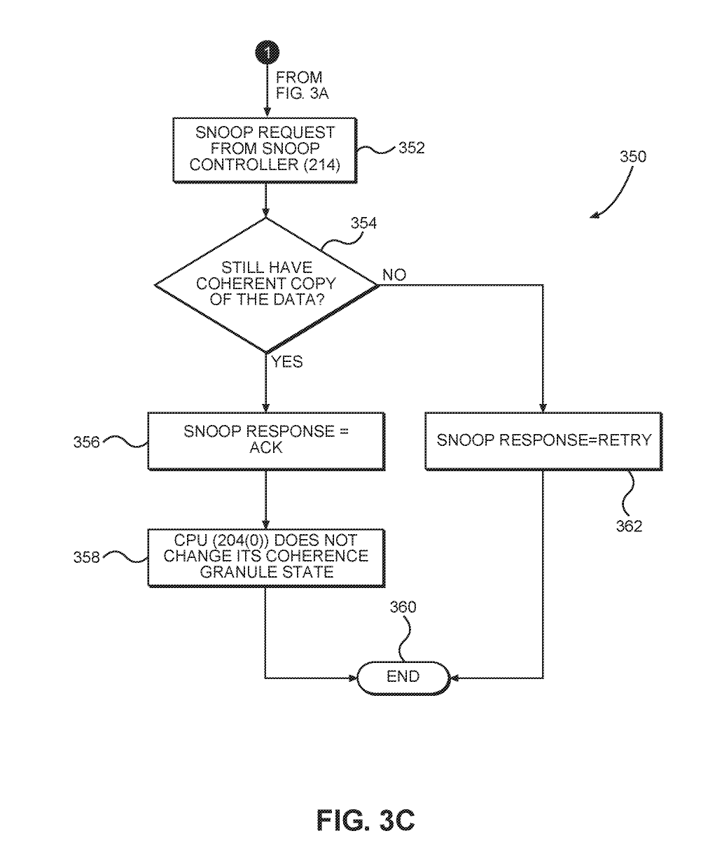

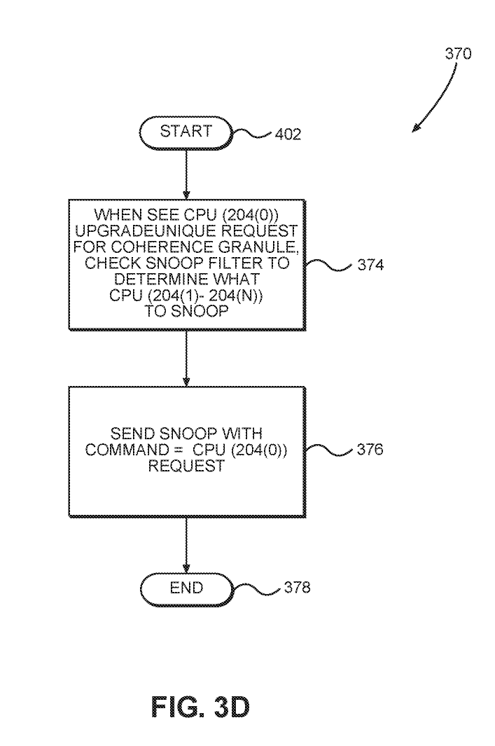

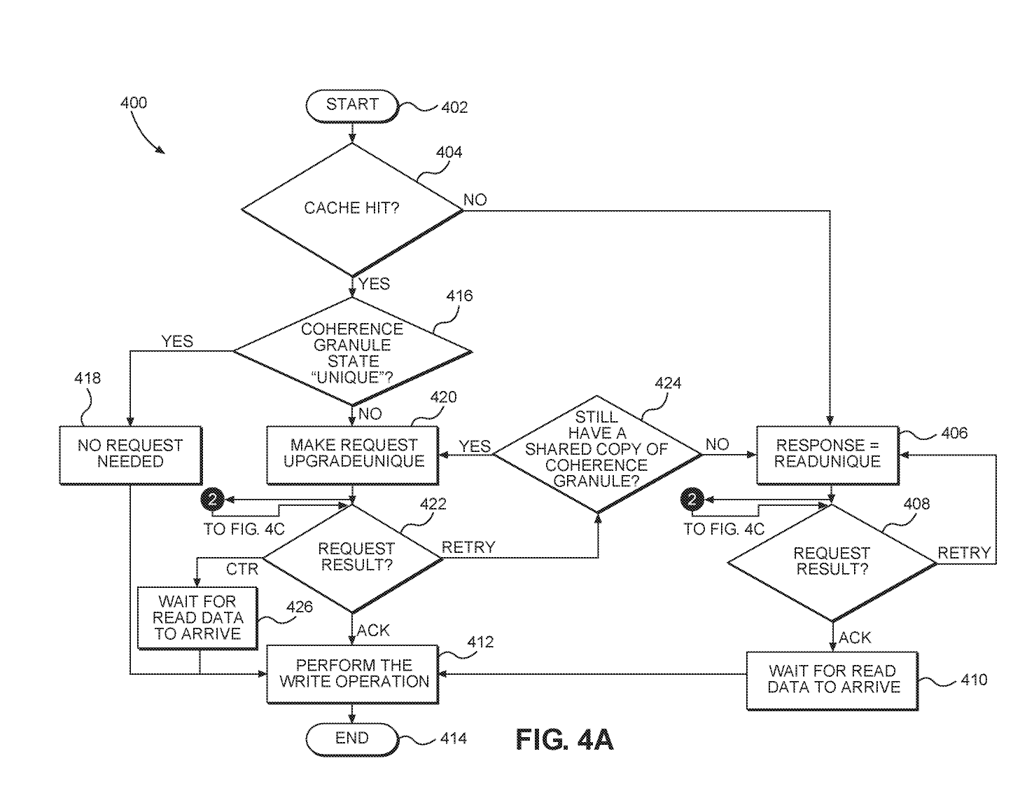

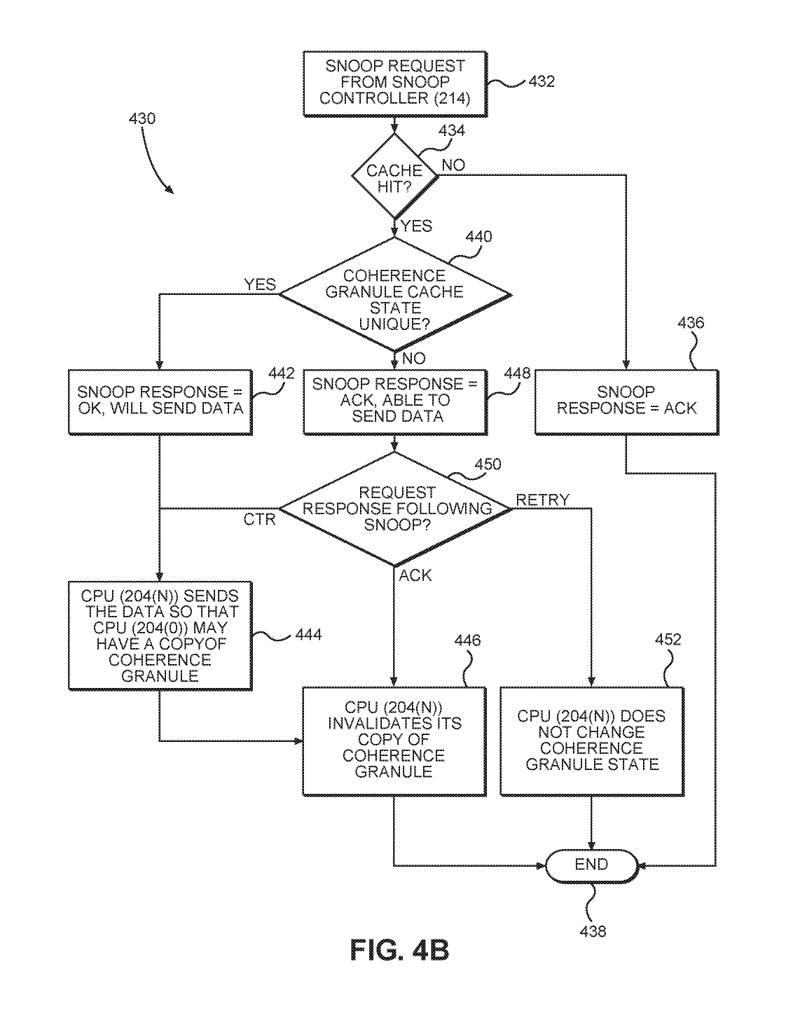

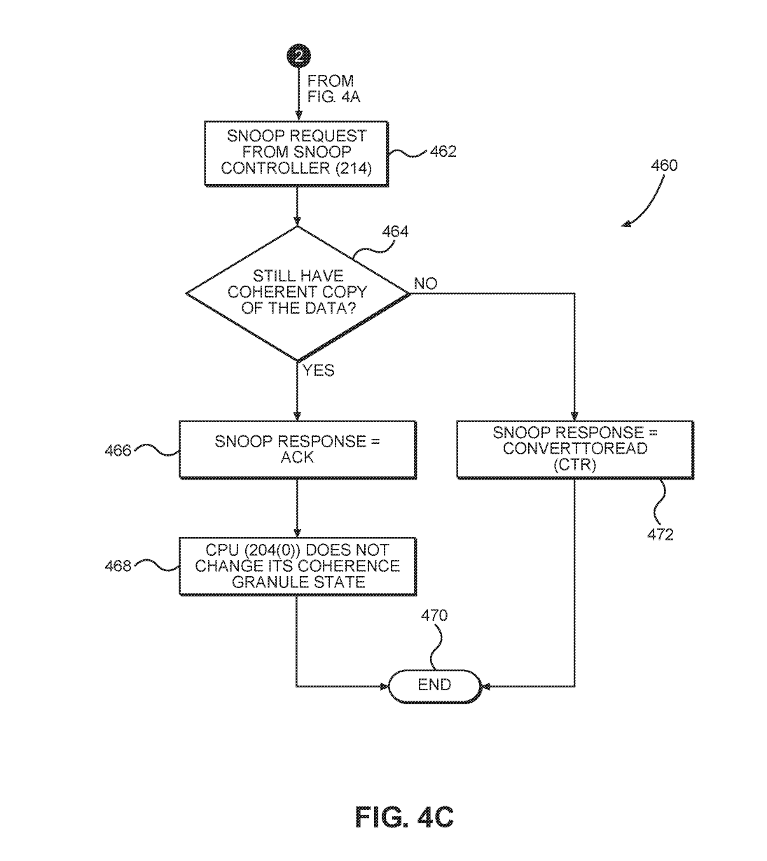

Before discussing a CPU 204(0)-204(N) in FIG. 2 being configured to convert a cache memory unique request that becomes stale to a read unique snoop response in a multi-CPU processor starting at FIG. 4A, FIGS. 3A-3C are first described. FIG. 3A is a flowchart illustrating an exemplary process 300 of a CPU 204(0)-204(N) in the multi-CPU processor 202 in FIG. 2 performing a write operation to a coherence granule in its associated cache memory 206, 206S(0)-206S(X) without converting a stale upgrade unique request to a read unique snoop response. A CPU 204(0)-204(N) being configured to convert a stale upgrade unique request to a read unique snoop response starts at FIG. 4A. The process 300 in FIG. 3A is described below as being performed by CPU 204(0), but note that any CPU 204(0)-204(N) can perform the process 300 in FIG. 3A for a write operation.

For example, assume that CPU 204(0), acting as a master CPU, desires to write eight (8) bytes within a particular coherence granule in its associated cache memory 206. In this regard, as illustrated in FIG. 3A, the process 300 starts (block 302), and the CPU 204(0) determines if the write operation is to a memory address that is contained in its associated cache memory 206, meaning a cache hit occurs (block 304). For example, the CPU 204(0) will determine if a cache hit occurs in any of its private cache memory, including any internal level 1 (L1) cache memory and the private cache memory 206. If there is no cache hit, this means that the cache memory 206 associated with the CPU 204(0) does not contain a valid cache entry associated with the memory address of the write operation. In this instance, the CPU 204(0) acting as a master CPU (sometimes referred to herein as “master CPU”) issues a read unique request on the interconnect bus 212 to load the data associated with the memory address of the write operation into the cache memory 206 in a unique cache state (block 305). The snoop controller 214 may be configured to issue a snoop request to the other CPUs 204(1)-204(N) based on receiving the read unique request from CPU 204(0). The CPU 204(0) snoops the request. A response is generated on the interconnect bus 212 indicating if the read unique request can be serviced by another CPU 204(1)-204(N). The CPU 204(0) determines if the read unique request was successful (i.e., ACK) based on a request result issued by the CPU 204(0) as a snoop response to the snoop controller 214 in response to a snoop request received from the interconnect bus 212 (block 306). If not successful, the CPU 204(0) retries the read unique request by reissuing the read unique request on the interconnect bus 212. If the read unique request was successful, CPU 204(0) waits for the read data to arrive on the interconnect bus 212 from another CPU 204(1)-204(N) acting as a snooper CPU (sometimes referred to herein as “snooper CPU”) that supplied the data on the interconnect bus 212 (block 308). This snooper CPU 204(1)-204(N) will mark its copy of the coherence granule requested in the read unique request as invalid since the requesting CPU 204(0) requested a copy of the data in a unique cache state. CPU 204(0) can then write the data for its write operation in the portion of the coherence granule to be updated for the memory address associated with the write operation in its cache memory 206 (block 310), and the process 300 ends (block 312). Other lower level cache memories, if included in the CPU 204(0), may also be updated.

With continuing reference to FIG. 3A, if a cache hit occurred for the write operation in block 304, the CPU 204(0) determines if the cache state of the coherence granule to be written for the write operation is in a unique cache state (block 314). If the cache state of the coherence granule to be written is unique, this means that no request is needed to be issued on the interconnect bus 212 to read in the data associated with the coherence granule from another cache memory (block 316). CPU 204(0) can write the data for its write operation in the portion of the coherence granule to be updated for the memory address associated with the write operation in its cache memory 206 (block 310), and the process 300 ends (block 312).

With continuing reference to FIG. 3A, if the cache state of the coherence granule to be written for the write operation is not in a unique cache state in block 314, this means that the cache memory 206 for the CPU 204(0) contains data for the coherence granule in a shared cache state. A shared cache state means that at least one other cache memory 206S(0)-206S(X) may contain the coherence granule associated with the memory address of the write operation. In this regard, the CPU 204(0) issues an upgrade unique request on the interconnect bus 212 to take the shared coherence granule unique (i.e., exclusive) from all other CPUs 204(1)-204(N) (block 318). The CPU 204(0) determines if the upgrade unique request was successful in response to a snoop response from the snoop controller 214 (block 320), which is discussed later below in regard to FIG. 3C. With reference back to FIG. 3A, if the CPU 204(0) determines that the upgrade unique request was successful, the CPU 204(0) acknowledges the snoop response (i.e., ACK) and then writes the data for its write operation in the portion of the coherence granule to be updated for the memory address associated with the write operation in its cache memory 206 (block 310), and the process 300 ends (block 312).

If the CPU 204(0) determines that the upgrade unique request was not successful in response to the snoop response issued by the snoop controller 214, this may be the result of another CPU(s) 204(1)-204(N) having issued a unique upgrade request to the same coherence granule as requested to be upgraded by CPU 204(0), where a unique upgrade request by another CPU(s) 204(1)-204(N) was serviced by the snoop controller 214 before the unique upgrade request issued by the CPU 204(0). CPU 204(0) is not permitted to write data to the coherence granule until it holds the coherence granule in its cache memory 206 in a unique cache state. In this regard, the CPU 204(0) issues a retry snoop response (i.e., RETRY) to the snoop controller 214 (discussed below in FIG. 3C), and then the CPU 204(0) determines if it still has a copy of the data associated with the coherence granule in its cache memory 206 (block 322). This is because another unique upgrade request issued by another CPU(s) 204(1)-204(N) caused the snoop controller 214 to issue a snoop kill request for the coherence granule so that the requesting CPU 204(1)-204(N) holds the coherence granule uniquely. If CPU 204(0) determines it still has a copy of the data associated with the coherence granule in block 322, the CPU 204(0) can retry the issuance of the upgrade unique request since another CPU(s) 204(1)-204(N) did not issue a unique upgrade request that resulted in the data for the coherence granule being killed (i.e., invalidated) in the CPU 204(0). Thus, the unique upgrade request can be retried by CPU 204(0) (block 318). However, if the CPU 204(0) determines it does not have a valid copy of the data associated with the coherence granule, this means that another CPU(s) 204(1)-204(N) has already taken the coherence granule as unique, thus making the upgrade unique request by the CPU 204(0) stale, meaning the upgrade unique request is no longer valid to be processed to make the coherence granule unique to the CPU 204(0). For example, the upgrade unique request may have been valid at the time it was requested by the CPU 204(0), but became stale between the time the request was made and the time the associated snoop was generated by the snoop controller 214. By the time the other snooper CPUs 204(1)-204(N) required the associated snoop request, conditions had changed such that the upgrade unique request issued by the CPU 204(0) became stale and thus should not be able to be completed without other actions being taken.

As discussed above for FIG. 3A, the stale upgrade unique request could have been retried by the CPU 204(0). However, retrying a stale cache memory unique request results in the retried request being reordered behind other pending, younger requests by the snoop controller 214 that can lead to lack of forward progress due to starvation or livelock. Performance would be lost due to the extra time needed to send the result all the way back to the CPU 204(0) before it can get started on its resend of the bus request as a read unique request.

FIG. 3B is a flowchart illustrating an exemplary process 330 of another second, snooper CPU 204(1)-204(N) in the multi-CPU processor 200 in FIG. 2 snooping the converted read unique snoop response from the snoop controller 214. Assume the second, snooper CPU 204(1)-204(N) is CPU 204(N) for this example. The snoop controller 214 issues a snoop request to the CPU 204(N) that contains a valid copy of the coherence granule to be written by the CPU 204(0) as part of a failed upgrade unique request by the CPU 204(0). CPU 204(N) that holds a coherent form of data associated with the memory address associated with the stale cache memory unique request from the CPU 204(0) snoops the state of the upgrade unique request issued by the CPU 204(0) and provides a snoop response based on its own state (e.g., whether it can provide data). Later, the CPU 204(N) receives a bus request response which lets it know whether the upgrade unique request has been converted to a read unique request.

As shown in FIG. 3B, the process 330 starts with the CPU 204(N) receiving a snoop request from the snoop controller 214 in response to the upgrade unique request issued by the CPU 204(0) described in the process 300 in FIG. 3A (block 332). In response, the CPU 204(0) determines if the data associated with the upgrade unique request is contained in its cache memory, meaning a cache hit (block 334). If not a cache hit, the second CPU 204(N) sends an acknowledgement snoop response (i.e., ACK) on the interconnect bus 212 meaning that CPU 204(N) does not have data to send to satisfy the upgrade unique request (block 336), and the process 330 ends (block 338). If a cache hit is determined to have occurred in block 334, the second CPU 204(N) sends an acknowledgement snoop response on the interconnect bus 212 indicating that it is able to send the data associated with the coherence granule to satisfy the upgrade unique request (block 340). The second CPU 204(N) then determines if a request on the interconnect bus 212 following its snoop response is an upgrade unique request, a retried upgrade unique request, or a converted read snoop unique request (CTR) from CPU 204(0) (block 342). The second CPU 204(N) then waits for the bus request response from the interconnect bus 212 to come, which considers the snoop responses from the other snooper CPUs 204(1)-204(N−1) that received the upgrade unique request issued by the CPU 204(0). If the bus request response indicates “ACK”, this means that no other snooper CPU 204(0)-204(N−1) has retried the upgrade unique request and master CPU 204(0) has not asked that the upgrade unique request be converted to a read unique request. Therefore, the upgrade unique request has succeeded, and the master CPU 204(0) may go to a unique cache state for the coherence granule, and the snooper CPU 204(N) invalidates its copy of the coherence granule (block 344) and the process 300 ends (block 338). The master CPU 204(0) was able to go to a unique cache state, because no data needed to be moved since the CPU 204(0) did not lose a copy of the coherence granule. If however, the bus request response indicates “RETRY”, the second CPU 204(N) does not change the cache state of the coherence granule since this means that master CPU 204(0) is retrying the unique upgrade request (block 346). If the request is a converted read unique request, the CPU 204(N) sends the data associated with the coherence granule for the converted read unique request on the interconnect bus 212 to be provided to CPU 204(0) (block 348), and the CPU 204(N) invalidates its copy of data for the coherence granule (block 344) and the process 300 ends (block 338).

FIG. 3C is a flowchart illustrating an exemplary process 350 of the master CPU 204(0) receiving a snoop request in response to the CPU 204(0) issuing a unique snoop request in block 318 or a read unique request in block 305 issued in the exemplary process 300 in FIG. 3A as a way to know that its issued unique request was not serviced and thus became stale. The CPU 204(0)'s response to the snoop response can cause the snoop controller 214 to convert the CPU's 204(0) upgrade unique request that became stale to a converted read unique snoop response as previously discussed.

In this regard, the CPU 204(0) receives a snoop request from the snoop controller 214 in response to a unique request issued by the CPU 204(0) discussed in FIG. 3A above indicating if the unique request issued by the CPU 204(0) was successful (block 352). In response, the CPU 204(0) determines if it still has a coherent copy of the data associated with the coherence granule for the upgrade unique request (block 354). If so, the CPU 204(0) issues a snoop response acknowledging the snoop request (i.e., ACK) to the interconnect bus 212 (block 356), and CPU 204(0) does not change the cache state of the coherence granule (block 358) and the process 350 ends (block 360). This is because the upgrade unique request has not become stale due to another CPU 204(1)-204(N) having issued an upgrade unique request to obtain the coherence granule in a unique cache state to perform a write operation and been given the unique cache state for the coherence granule. The CPU 204(0) still having a coherent copy of the data associated with the coherence granule for the upgrade unique request means it was not killed as a result of another upgrade unique request by another CPU 204(1)-204(N) for the coherence granule being serviced first.

However, if the CPU 204(0) determines that it does not have coherent copy of the data associated with the coherence granule for the upgrade unique request in block 354, this means that a snoop kill caused the CPU 204(0) to invalidate its copy of the data associated with the coherence granule in its cache memory. In other words, another upgrade unique request issued by another CPU 204(1)-204(N) already obtained the coherence granule in a unique state to perform a write operation. In this case, the CPU 204(0) can issue a snoop response as a RETRY to cause the snoop controller 214 to retry the upgrade unique request to try to once again obtain the coherence granule in the unique cache state for the write operation. The CPU 204(0) retries either the upgrade unique request or the read unique request depending on whether the process was invoked by an upgrade unique request or a read unique request, as shown in FIG. 3A (block 362). The process 350 then ends (block 360).

FIG. 3D is a flowchart illustrating an exemplary process 370 of the snoop controller 214 in the processor-based system 200 in FIG. 2 receiving the cache memory unique request issued by the first CPU 204(0) that has become stale and filtering the request to determine which second CPU 204(1)-204(N) should snoop the stale cache memory unique request as part of the process 330 in FIG. 3B. In this regard, the process 370 starts (block 372). When the snoop controller 214 sees the upgrade unique request from CPU 204(0) for the coherence granule, the snoop controller 214 checks a snoop filter to determine which other CPU 204(1)-204(N) to send the snoop request to (block 374). Alternatively, the snoop request is sent to all CPUs 204(1)-204(N) if no snoop filter is employed. The snoop controller 214 then sends the snoop request for the upgrade unique request from CPU 204(0) to the determined CPU 204(1)-204(N) (or all CPUs 204(1)-204(N)) on the interconnect bus 212 (block 376), and the process 370 ends (block 378).

As discussed above with regard to FIGS. 3A and 3C, the CPU 204(0) can issue a snoop response to cause the snoop controller 214 to retry its unique requests that have become stale to allow the CPU 204(0) to perform its write operation for a coherence granule behind the CPU 204(1)-204(N) that previously won their unique request for the same coherence granule. However, retrying unique requests may cause the retried request to be reordered behind other pending, younger requests. This can lead to a lack of forward progress of retried unique requests due to starvation or livelock. Thus, in aspects disclosed herein, to avoid the retried unique requests being reordered behind other pending, younger requests which would lead to lack of forward progress due to starvation or livelock, snooped stale unique requests can be converted to read unique snoop responses so that their request order can be maintained in the cache memory system.

In this regard, FIG. 4A illustrates an exemplary process 400 of a CPU 204(0)-204(N), such as CPU 204(0) in the multi-CPU processor 202 in FIG. 2 performing a write operation to a coherence granule in its associated cache memory 206. CPU 204(0) will be used in this example as a master CPU performing the write operation. In this regard, the process 400 starts (block 402), and the CPU 204(0) determines if the write operation is to a memory address that is contained in its associated cache memory 206, meaning a cache hit occurs (block 404). If there is no cache hit, this means that the cache memory 206 associated with the CPU 204(0) does not contain a valid cache entry associated with the memory address of the write operation. In this instance, the CPU 204(0) acting as a master CPU issues a read unique request on the interconnect bus 212 to load the data associated with the memory address of the write operation into the cache memory 206 in a unique cache state (block 406). The snoop controller 214 may be configured to issue a snoop request to the other CPUs 204(1)-204(N) based on receiving the read unique request from CPU 204(0). The CPU 204(0) snoops the request. A snoop response is generated on the interconnect bus 212 indicating if the read unique request can be serviced by another CPU 204(1)-204(N). The CPU 204(0) issues a request result indicating if the read unique request was successful in response to a snoop response to the issued read unique request, which will be discussed in more detail below with regard to FIG. 4C (block 408). If the request result is a RETRY meaning the read unique request was not successful, the CPU 204(0) retries the read unique request by reissuing the read unique request on the interconnect bus 212. If the read unique request was successful based on the request result being an acknowledgement of the snoop response (e.g., ACK) (block 408), CPU 204(0) waits for the read data to arrive on the interconnect bus 212 from another snooper CPU 204(1)-204(N) that supplied the data on the interconnect bus 212 (block 410). This other snooper CPU 204(1)-204(N) will mark its copy of the coherence granule requested in the read unique request as invalid since the requesting CPU 204(0) requested a copy of the data in a unique cache state. CPU 204(0) can then write the data for its write operation in the portion of the coherence granule to be updated for the memory address associated with the write operation in its cache memory 206 (block 412), and the process 400 ends (block 414). Other lower level cache memories, if included in the CPU 204(0), may also be updated.

With continuing reference to FIG. 4A, if a cache hit occurred for the write operation in block 404, the CPU 204(0) determines if the cache state of the coherence granule to be written for the write operation is a unique cache state (block 416). If the cache state of the coherence granule to be written is unique, this means that no request is needed to be issued on the interconnect bus 212 to read in the data associated with the coherence granule from another cache memory 206 (block 418). CPU 204(0) can write the data for its write operation in the portion of the coherence granule to be updated for the memory address associated with the write operation in its cache memory 206 (block 412), and the process 400 ends (block 414).

With continuing reference to FIG. 4A, if the cache state of the coherence granule to be written for the write operation is not in a unique cache state in block 416, this means that the cache memory 206 for the CPU 204(0) contains data for the coherence granule in a shared cache state. A shared cache state means that there may be at least one other cache memory 206S(0)-206S(X) that contains the coherence granule associated with the memory address of the write operation. In this regard, the CPU 204(0) issues an upgrade unique request on the interconnect bus 212 to take the shared coherence granule unique (i.e., exclusive) from all other CPUs 204(1)-204(N) (block 420). The CPU 204(0) generates a request result indicating if the upgrade unique request was successful in response to a snoop response to the upgrade unique request, which is discussed in more detail below with regard to FIG. 4C (block 422). If the request result indicates that the upgrade unique request succeeded based on an acknowledgement response (e.g., ACK) to the snoop response issued by the CPU 204(0) (block 422), the CPU 204(0) writes the data for its write operation in the portion of the coherence granule to be updated for the memory address associated with the write operation in its cache memory 206 (block 412), and the process 400 ends (block 414).

However, if the request response from the CPU 204(0) is “RETRY” (block 422), this may be the result of another CPU(s) 204(1)-204(N) having issued a unique upgrade request to the same coherence granule as requested to be upgraded by CPU 204(0), where a unique upgrade request by another CPU(s) 204(1)-204(N) was serviced by the snoop controller 214 before the unique upgrade request issued by the CPU 204(0). CPU 204(0) is not permitted to write data to the coherence granule until it holds the coherence granule in its cache memory 206 in a unique cache state. In this regard, the CPU 204(0) determines if it still has a copy of the data associated with the coherence granule in its cache memory 206 (block 424). This is because another unique upgrade request issued by another CPU(s) 204(1)-204(N) causes the snoop controller 214 to issue a snoop kill request for the coherence granule so that the requesting CPU 204(1)-204(N) has the coherence granule uniquely. If CPU 204(0) determines it still has a copy of the data associated with the coherence granule in block 424, the CPU 204(0) can resend the issuance of the upgrade unique request since another CPU(s) 204(1)-204(N) did not issue a unique upgrade request that resulted in the data for the coherence granule being killed (i.e., invalidated) in the CPU 204(0). However, if the CPU 204(0) determines is does not have a valid copy of the data associated with the coherence granule, this means that another CPU(s) 204(1)-204(N) has already taken the coherence granule as unique, thus rendering stale the upgrade unique request by the CPU 204(0).

With continuing reference to FIG. 4A, if the request result from the CPU 204(0) in response to the snoop response is convert-to-read (“CTR”) (block 422), this indicates that the stale upgrade unique request has been converted to a read unique request by the snoop controller 214 in response to the snoop response by the CPU 204(0). Thus, the CPU 204(0) does not have to retry the previously issued upgrade unique request. This may have been the result of another CPU(s) 204(1)-204(N) having issued a unique upgrade request to the same coherence granule as requested to be upgraded by CPU 204(0), where an unique upgrade request by another CPU(s) 204(1)-204(N) was serviced by the snoop controller 214 before the unique upgrade request issued by the CPU 204(0). The other CPU(s) 204(1)-204(N) that has the coherence granule will provide the data to the CPU 204(0) in response to the converted read unique request response asserted on the interconnect bus 212 (block 426).

As discussed above, the snoop controller 214 converting a stale upgrade unique request to a read unique request via the snoop response by the CPU 204(0) to the upgrade unique request for the original upgrade unique request prevents the snoop controller 214 from reordering the converted read unique request behind other pending, younger requests which would lead to lack of forward progress due to starvation or livelock. The stale upgrade unique request is converted to a read unique so that its request order is maintained by the snoop controller 214. The CPU 204(0) is configured to not issue a retry of the upgrade unique request. In this manner, the request order for the original issued upgrade unique request is maintained by the snoop controller 214. This may be particularly useful if other CPUs 204(1)-204(N) are trying to read the same coherence granule, whereby retried upgrade unique requests by CPU 204(0) would keep failing and being invalidated, thus starving out the write operation to the coherence granule by CPU 204(0).

As discussed above, the CPU 204(N) can also be configured to behave as if a read unique request was received from the CPU 204(0) and indicate a willingness to send the data after written to the interconnect bus 212 to reduce the latency involved with servicing future read unique requests. The CPU 204(0) then writes the data for its write operation in the portion of the coherence granule to be updated for the memory address associated with the write operation in its cache memory 206 (block 412), and the process 400 ends (block 414).

In another exemplary aspect, using the example of CPU 204(N) whose upgrade unique request won and was serviced with the data for the coherence granule in a unique cache state to be written, such CPU 204(N) can snoop the in-flight unique requests from the CPU 204(0) for the same coherence granule. Thus, the CPU 204(N) that received the data in the unique cache state knows that the CPU 204(0) that issued the in-flight unique requests for the same coherence granule will eventually request the data for the coherence granule in a unique state to then carry out its write operations. The CPU 204(N) that received the data in the unique cache state can behave as if a read unique request was received from the CPU 204(0) and indicate a willingness to send the data after written to the interconnect bus 212 to reduce the latency involved with servicing future read unique requests.

In this regard, FIG. 4B is a flowchart illustrating an exemplary process 430 of the CPU 204(N) in the multi-CPU processor 202 in FIG. 2, acting as a snooper CPU and snooping the upgrade unique request from CPU 204(0) from the process 400 in FIG. 4A. The CPU 204(N) snoops the snoop request from the snoop controller 214 in response to the unique request from CPU 204(0) (block 432). The snoop request was generated by the snoop controller 214 in response to the converted read unique snoop response received from CPU 204(0). In response, the snooper CPU 204(N) determines if the data associated with the read unique request is contained in its cache memory 206, meaning a cache hit (block 434). If there is not a cache hit, the second CPU 204(N) sends an acknowledgement snoop response, “ACK”, on the interconnect bus 212 indicating that it does not have data to send to satisfy the read unique request (block 436), and the process 430 ends (block 438). If a cache hit is determined to have occurred in block 434, the CPU 204(N) determines if the coherence granule is in a unique cache state (block 440). If so, the CPU 204(N) sends a snoop response indicating that it will send the data for the coherence granule on the interconnect bus 212 (block 442). The CPU 204(N) then sends the data to the coherence granule on the interconnect bus 212 (block 444). The CPU 204(N) invalidates its copy of data for the coherence granule (block 446), and the process 430 ends (block 438). If the CPU 204(N) determines the coherence granule is not in a unique cache state in block 440, the CPU 204(N) also sends a snoop response indicating that it is willing to send the data for the coherence granule on the interconnect bus 212 (block 448). The CPU 204(N) determines if the request response following the snoop is a retry of the upgrade unique request by the CPU 204(0) or a converted read unique request response (block 450). If a retry, the CPU 204(N) does not change its cache state of the coherence granule (block 452), and the process 430 ends (block 438). If the result is a converted read unique request response, the CPU 204(N) sends the data to the coherence granule on the interconnect bus 212 (block 444), and invalidates its copy of data for the coherence granule (block 446), and the process 430 ends (block 438).

FIG. 4C is a flowchart illustrating an exemplary process 460 of the master CPU 204(0) receiving a snoop response from the snoop controller 214 in response to the CPU 204(0) issuing a unique request in the exemplary process 400 in FIG. 4A. The CPU 204(0) is configured to determine if its issued upgrade unique request has become stale. In this manner, the CPU 204(0) can issue a snoop response to cause the snoop controller 214 to convert the stale upgrade unique request to a converted read unique snoop response as previously discussed. In this regard, the process 460 starts by the CPU 204(0) receiving a snoop response from the snoop controller 412 (block 462). The CPU 204(0) determines if it still has a coherent copy of the data associated with the coherence granule for the upgrade unique request (block 464). If so, the CPU 204(0) sends an acknowledgement of the snoop response to the interconnect bus 212 (block 466) and CPU 204(0) does not change the cache state of the coherence granule (block 468), and the process 460 ends (block 470). This is because the upgrade unique request is not yet stale in that another CPU 204(1)-204(N) that issued an upgrade unique request has yet to obtain the coherence granule in a unique state to perform a write operation. The CPU 204(0) still having a coherent copy of the data associated with the coherence granule for the upgrade unique request means it was not killed as a result of another upgrade unique request by another CPU 204(1)-204(N) for the coherence granule being serviced first.

However, if the CPU 204(0) determines that it does not have coherent copy of the data associated with the coherence granule for the upgrade unique request in block 464 in FIG. 4C, this means that a snoop kill caused the CPU 204(0) to invalidate its copy of the data associated with the coherence granule in its cache memory 206. In other words, another upgrade unique request issued by another CPU 204(1)-204(N) already obtained the coherence granule in a unique state to perform a write operation. In this case, the CPU 204(0) can convert the upgrade unique request to a converted read unique snoop response to avoid having to reissue or retry the upgrade unique request (block 472). As previously discussed, this can avoid the retried unique requests being reordered behind other pending, younger requests by the snoop controller 214, which would lead to lack of forward progress due to starvation or livelock. The process 460 then ends (block 470).

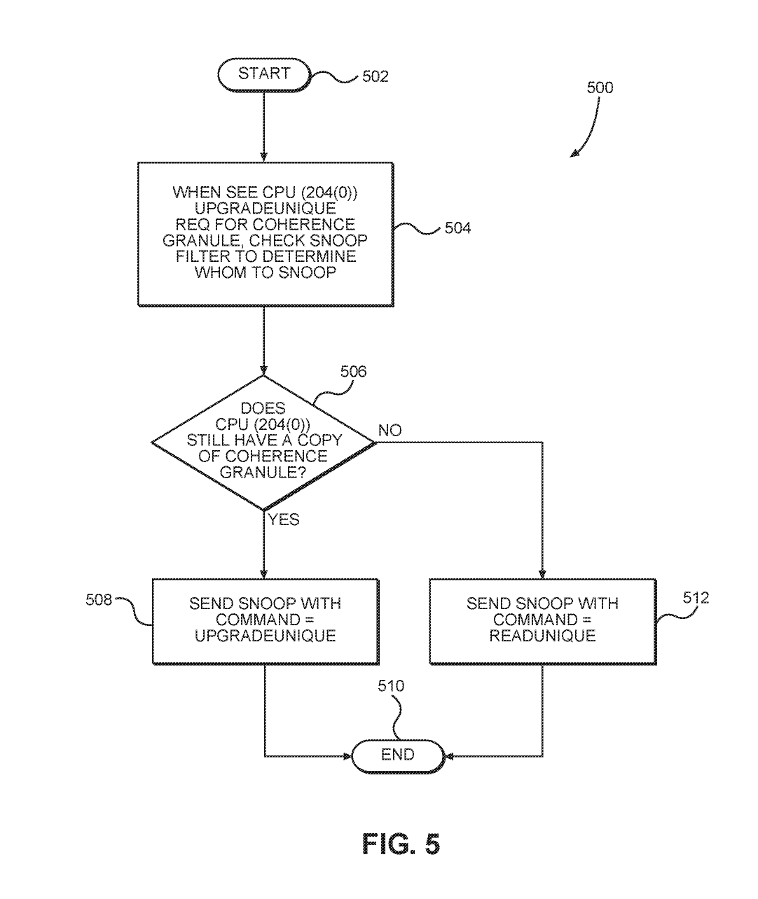

FIG. 5 is a flowchart illustrating an exemplary process 500 of the snoop controller 214 in the processor-based system 200 in FIG. 2 determining the cache memory unique request issued by the CPU 204(0) has become stale and automatically converting the stale cache memory unique request to a converted read unique request on the interconnect bus 212 to be snooped by CPU 204(N). The snoop controller 214 can convert the stale cache memory unique request to a converted read unique request without the CPU 204(0) issuing a retry of the upgrade unique snoop response like provided in the exemplary process 300 in FIG. 3A. In this regard, the process 500 starts (block 502). When the snoop controller 214 sees the upgrade unique request from CPU 204(0) for the coherence granule, the snoop controller 214 checks a snoop filter to determine which other CPU 204(1)-204(N) to send the snoop request to (block 504). Alternatively, the snoop request is sent to all CPUs 204(1)-204(N) if no snoop filter is employed. The snoop controller 214 determines if CPU 204(0) still has a copy of the coherence granule based on a snoop response received from the CPU 204(0) discussed in the process 460 in FIG. 4C (block 506). If so, this means that the coherence granule was not snoop killed. The snoop controller 214 can send a snoop request with the upgrade unique request of CPU 204(0) (block 508), and the process 500 ends (block 510). However, if snoop controller 214 determines that CPU 204(0) does not still have a copy of the coherence granule in block 506, the snoop controller 214 can automatically convert the upgrade unique request of CPU 204(0) to a read unique request (block 512) so that the CPU 204(0) gets an updated copy of the coherence granule before performing a write operation, and the process 500 ends (block 510). In this manner, the snoopers, such as CPU 204(N), can automatically send data for the coherence granule without having to wait to see whether the upgrade unique request has been converted to a read unique snoop response.

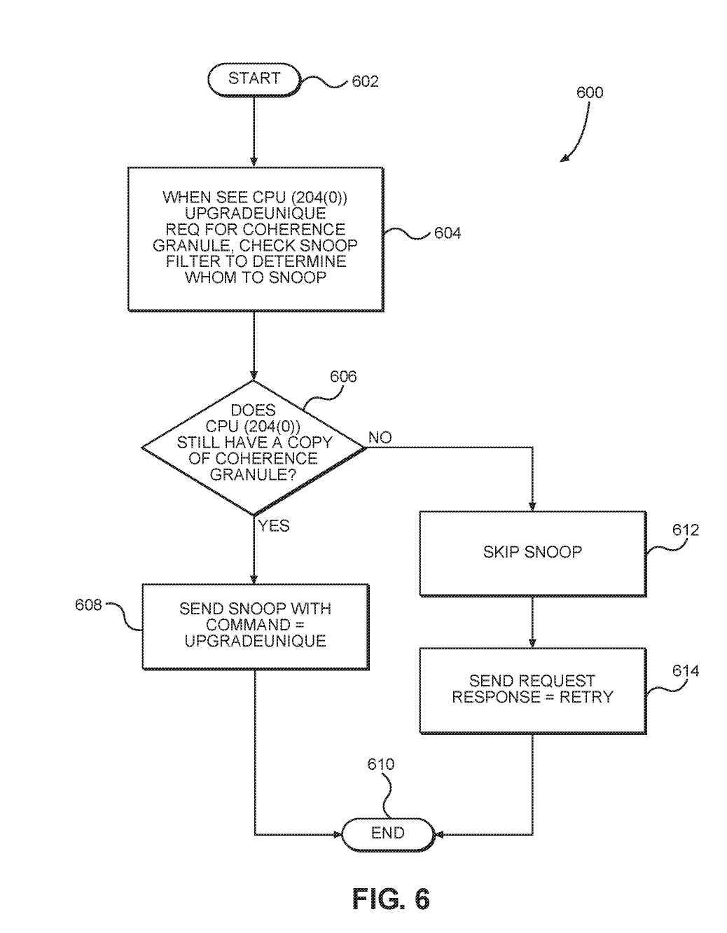

FIG. 6 is a flowchart illustrating an exemplary process 600 of the snoop controller 214 in the processor-based system 200 in FIG. 2 if the CPU 204(0) is configured to retry a stale upgrade unique request in the event that such feature is not available or disabled. The snoop controller 214 is configured to retry the upgrade unique request without having to issue a snoop request to the CPU 204(N) that has a copy of the coherence granule requested by the CPU 204(0) from a previous issued upgrade unique request. This is because the snoop controller 214 knows that the CPU 204(0) will retry its own upgrade unique request, and thus can send the request response of “RETRY” on the interconnect bus 212 sooner without needing to generate the snoop request to the CPU 204(1)-204(N) that has the coherence granule.

In this regard, with reference to FIG. 6, the process 600 starts (block 602). When the snoop controller 214 sees the upgrade unique request from CPU 204(0) for the coherence granule, the snoop controller 214 checks a snoop filter to determine which other CPU 204(1)-204(N) to send the snoop request (block 604). Alternatively, the snoop request is sent to all CPUs 204(1)-204(N) if no snoop filter is employed. The snoop controller 214 determines if CPU 204(0) still has a copy of the coherence granule (block 606). If so, this means that the coherence granule was not snoop killed. The snoop controller 214 can send a snoop request with the upgrade unique request of CPU 204(0) (block 608), and the process 600 ends (block 610). However, if the snoop controller 214 determines that CPU 204(0) does not still have a copy of the coherence granule in block 606, the snoop controller 214 can skip the snoop (block 612) and automatically send a request response of “RETRY” to CPU 204(0) on the interconnect bus 212 so that the CPU 204(0) may re-issue a read unique request to obtain an updated copy of the coherence granule before performing a write operation (block 614), and the process 600 ends (block 610).

Multi-CPU processors that are configured to convert stale cache memory upgrade unique request to read unique snoop responses to reduce latency associated with reissuing the stale cache memory unique requests, and according to any aspects disclosed herein, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

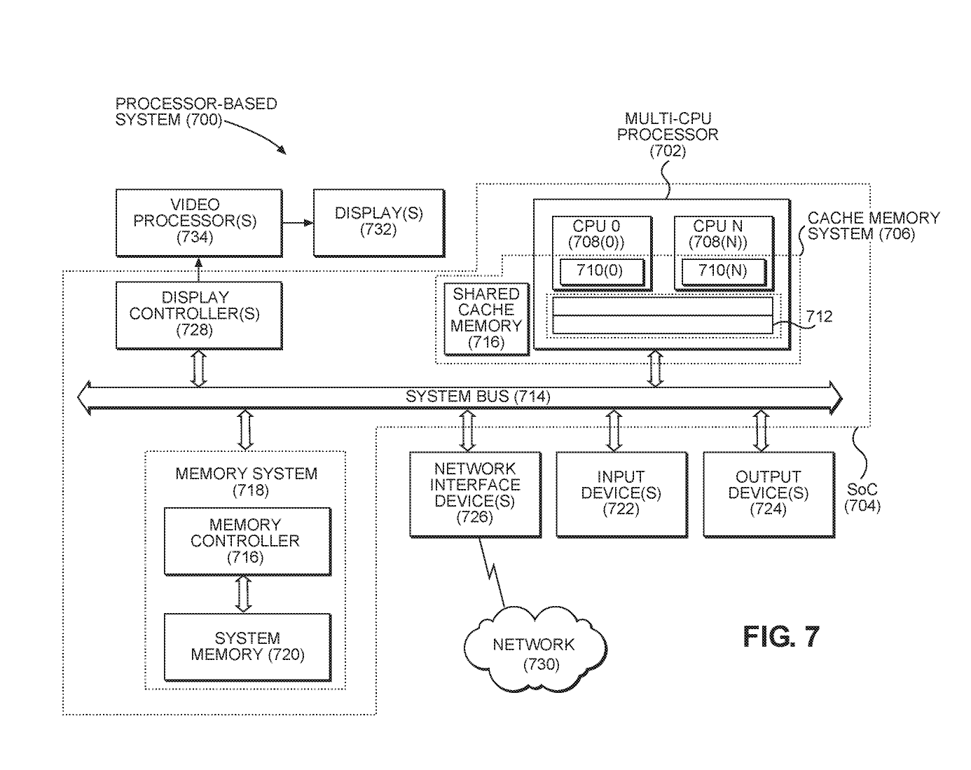

In this regard, FIG. 7 illustrates an example of a processor-based system 700 that includes a multi-CPU processor 702 configured to convert stale cache memory upgrade unique requests to read unique snoop responses to reduce latency with reissuing the stale cache memory unique requests, and according to any aspects disclosed herein. The processor-based system 700 includes the multi-CPU processor 702 that may be the multi-CPU processor 202 in FIG. 2. The processor-based system 700 may be provided as a system-on-a-chip (SoC) 704. The multi-CPU processor 702 includes a cache memory system 706. For example, the cache memory system 706 may be the cache memory system 210 in FIG. 2. In this example, the multi-CPU processor 702 includes multiple CPUs 708(0)-708(N). Local cache memories 710(0)-710(N) (e.g., L2 cache memories), which may be shared or private, are accessible to the CPUs 708(0)-708(N). The CPUs 708(0)-708(N) are each configured to convert stale cache memory upgrade unique requests to read unique snoop responses to maintain cache coherency among the cache memories 710(0)-710(N) with reduced latency. A shared cache memory 712 (e.g., a L3 cache memory) is also provided in the multi-CPU processor 702 and is accessible by the CPUs 708(0)-708(N). The CPUs 708(0)-708(N) are coupled to a system bus 714 and can intercouple peripheral devices included in the processor-based system 700. Although not illustrated in FIG. 7, multiple system buses 714 could be provided, wherein each system bus 714 constitutes a different fabric. As is well known, the CPUs 708(0)-708(N) communicates with other devices by exchanging address, control, and data information over the system bus 714. For example, the CPUs 708(0)-708(N) can communicate bus transaction requests to a memory controller 716 in a memory system 718 as an example of a slave device. In this example, the memory controller 716 is configured to provide memory access requests to system memory 720.

Other devices can be connected to the system bus 714. As illustrated in FIG. 7, these devices can include the memory system 718, one or more input devices 722, one or more output devices 724, one or more network interface devices 726, and one or more display controllers 728, as examples. The input device(s) 722 can include any type of input device, including but not limited to input keys, switches, voice processors, etc. The output device(s) 724 can include any type of output device, including but not limited to audio, video, other visual indicators, etc. The network interface device(s) 726 can be any devices configured to allow exchange of data to and from a network 730. The network 730 can be any type of network, including but not limited to a wired or wireless network, a private or public network, a local area network (LAN), a wireless local area network (WLAN), a wide area network (WAN), a BLUETOOTH™ network, and the Internet. The network interface device(s) 726 can be configured to support any type of communications protocol desired.

The CPUs 708(0)-108(N) may also be configured to access the display controller(s) 728 over the system bus 714 to control information sent to one or more displays 732. The display controller(s) 728 sends information to the display(s) 732 to be displayed via one or more video processors 734, which process the information to be displayed into a format suitable for the display(s) 732. The display(s) 732 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A multiple (multi-) central processing unit (CPU) processor, comprising:
an interconnect bus;
a snoop controller coupled to the interconnect bus;
a plurality of CPUs each communicatively coupled to the interconnect bus and each communicatively coupled to an associated cache memory; and
a master CPU among the plurality of CPUs configured to:
issue a unique request for a coherence granule on the interconnect bus to request a unique cache state for the coherence granule in its associated cache memory in response to a memory write operation comprising write data;
receive a snoop request on the interconnect bus from the snoop controller in response to issuing the unique request;
determine if the unique request issued on the interconnect bus became stale in response to another unique request issued by the master CPU among the plurality of CPUs for the coherence granule being assigned the unique cache state; and
in response to determining the unique request issued on the interconnect bus became stale, issue a snoop response on the interconnect bus to the snoop controller to convert the stale unique request to a read unique snoop response.

2. The multi-CPU processor of claim 1, wherein the master CPU is further configured to not retry the unique request in response to determining that the unique request issued on the interconnect bus became stale.

3. The multi-CPU processor of claim 1, wherein the master CPU is further configured to:
determine if the snoop request on the interconnect bus from the snoop controller indicates a retry of the unique request; and
in response to the snoop request indicating a retry of the unique request for the coherence granule on the interconnect bus:
issue a retry of the unique request for the coherence granule on the interconnect bus to request the unique cache state for the coherence granule in its associated cache memory; and
not issue the snoop response on the interconnect bus to the snoop controller to convert the stale unique request to a read unique snoop response.

4. The multi-CPU processor of claim 1, wherein the master CPU is further configured to, in response to determining that a memory address of the memory write operation is not contained in its associated cache memory:
determine if the coherence granule is in a unique cache state; and
in response to determining the coherence granule is in a unique cache state:
not issue the unique request for the coherence granule on the interconnect bus to request the unique cache state for the coherence granule in its associated cache memory; and
perform the memory write operation to the associated cache memory.

5. The multi-CPU processor of claim 1, wherein the master CPU is configured to determine that the unique request issued on the interconnect bus became stale by being configured to:
determine if its associated cache memory for the master CPU has a coherent copy of the write data associated with the coherence granule for the unique request; and
in response to determining that the associated cache memory for the master CPU does not have the coherent copy of the write data associated with the coherence granule for the unique request, determine that the unique request issued on the interconnect bus became stale.

6. The multi-CPU processor of claim 5, wherein the master CPU is configured to determine that the unique request issued on the interconnect bus became stale by being configured to:
determine if its associated cache memory for the master CPU has the coherent copy of the write data associated with the coherence granule for the unique request; and
in response to determining that the associated cache memory for the master CPU has the coherent copy of the write data associated with the coherence granule for the unique request, determine that the unique request issued on the interconnect bus did not become stale.

7. The multi-CPU processor of claim 1, wherein the master CPU is further configured to:
access its associated cache memory in response to the memory write operation;
determine if the memory address of the memory write operation is contained in its associated cache memory; and
in response to determining that the memory address of the memory write operation is not contained in its associated cache memory, issue an upgrade unique request as the unique request for the coherence granule on the interconnect bus to request a unique cache state for the coherence granule in its associated cache memory.

8. The multi-CPU processor of claim 7, wherein the master CPU is further configured to, in response to determining that the memory address of the memory write operation is contained in its associated cache memory, issue a read unique request for the unique request for the coherence granule on the interconnect bus to request a unique cache state for the coherence granule in its associated cache memory.

9. The multi-CPU processor of claim 8, wherein the master CPU is further configured to, in response to determining that the memory address of the memory write operation is contained in its associated cache memory,
receive the snoop response in response to the issued read unique request; and
in response to the received snoop response indicating the issued read unique request was successful:
issue a success acknowledgement on the interconnect bus; and
write received read data for the issued read unique request received from the interconnect bus from a snooper CPU among the plurality of CPUs in response to the success acknowledgement.

10. The multi-CPU processor of claim 8, wherein the master CPU is further configured to, in response to determining that the memory address of the memory write operation is contained in its associated cache memory,
receive the snoop response in response to the issued read unique request; and
in response to the received snoop response indicating the issued read unique request was not successful, issue a retry of the read unique request on the interconnect bus.

11. The multi-CPU processor of claim 1, wherein a snooper CPU among the plurality of CPUs is configured to:
snoop the unique request on the interconnect bus for the coherence granule in response to the unique request issued by the master CPU; and
issue a snoop response to the snoop controller on the interconnect bus indicating a willingness to provide data for the coherence granule from its associated cache memory over the interconnect bus to be snooped by at least one requesting CPU.

12. The multi-CPU processor of claim 11, wherein the snooper CPU is further configured to, in response to the issued snoop response indicating the willingness to provide the data for the coherence granule, send the data in the associated cache memory of the snooper CPU for the coherence granule on the interconnect bus.

13. The multi-CPU processor of claim 12, wherein the snooper CPU is further configured to invalidate the data in the associated cache memory of the snooper CPU for the coherence granule.

14. The multi-CPU processor of claim 1, wherein a snooper CPU among the plurality of CPUs is configured to:
snoop the unique request on the interconnect bus for the coherence granule in response to the unique request issued by the master CPU; and
issue a snoop response to the snoop controller on the interconnect bus with data for the coherence granule from its associated cache memory over the interconnect bus to be snooped by at least one requesting CPU.

15. The multi-CPU processor of claim 14, wherein the snooper CPU is further configured to:
receive a response from the snoop controller on the interconnect bus following the issued snoop response;
determine the response type of the response from the snoop controller on the interconnect bus following the issued snoop response; and
in response to determining that the type of the response from the snoop controller on the interconnect bus following the issued snoop response is a convert-to-read, send the data in the associated cache memory of the snooper CPU for the coherence granule on the interconnect bus.

16. The multi-CPU processor of claim 14, wherein the snooper CPU is further configured to, in response to determining that the type of the response from the snoop controller on the interconnect bus following the issued snoop response is a successful acknowledgement, set the coherence state of the data in the associated cache memory of the snooper CPU for the coherence granule to invalid.

17. The multi-CPU processor of claim 14, wherein the snooper CPU is further configured to, in response to determining that the type of the response from the snoop controller on the interconnect bus following the issued snoop response is a retry, not change the coherence state of the data in the associated cache memory of the snooper CPU for the coherence granule.

18. The multi-CPU processor of claim 1, wherein the snoop controller is configured to:
receive the unique request from the master CPU; and
in response to receiving the unique request from the master CPU:
issue a snoop request with the unique request on the interconnect bus; and
receive a snoop response from the master CPU indicating if the unique request has become stale; and
in response to the unique request becoming stale:
convert the unique request to a read unique request on the interconnect bus.

19. The multi-CPU processor of claim 18, wherein:
the snoop controller is further configured to determine at least one CPU among the plurality of CPUs whose associated cache memory contains the data for the coherence module for the unique request; and
the snoop controller is configured to issue the snoop request on the interconnect bus to the at least one CPU among the plurality of CPUs that contains the coherence granule.

20. The multi-CPU processor of claim 19, wherein:
the snoop controller is further configured to determine if the associated cache memory for the master CPU has the data for the unique request in a coherence state; and
in response to determining the associated cache memory for the master CPU does not have the data for the unique request in a coherence state, convert the unique request to a read unique snoop response.

21. The multi-CPU processor of claim 19, wherein:
the snoop controller is further configured to determine if the associated cache memory for the master CPU has the data for the unique request in a coherence state; and
in response to determining the associated cache memory for the master CPU does not have the data for the unique request in a coherence state:
not issue a snoop request on the interconnect bus to the at least one CPU among the plurality of CPUs that contains the coherence granule as an upgrade unique request; and
send a retry snoop response on the interconnect bus to the master CPU.

22. The multi-CPU processor of claim 19, wherein:
the snoop controller is further configured to determine if the associated cache memory for the master CPU has the data for the unique request in a coherence state; and
in response to determining the associated cache memory for the master CPU has the data for the unique request in a coherence state, issue the snoop request on the interconnect bus to the at least one CPU among the plurality of CPUs that contains the coherence granule as an upgrade unique request.

23. The multi-CPU processor of claim 1 integrated into a system-on-a-chip (SoC).

24. The multi-CPU processor of claim 1 integrated into a device selected from a group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

25. A method of converting a stale cache memory upgrade unique request to a read unique snoop response in a multiple (multi-) central processing unit (CPU) processor, comprising a plurality of CPUs each communicatively coupled to an interconnect bus and each communicatively coupled to an associated cache memory, comprising a master CPU among the plurality of CPUs, the method comprising:
issuing a unique request for a coherence granule on the interconnect bus to request a unique cache state for the coherence granule in its associated cache memory in response to a memory write operation comprising write data;
receiving a snoop request on the interconnect bus from a snoop controller in response to issuing the unique request;
determining if the unique request issued on the interconnect bus became stale in response to another unique request issued by the master CPU among the plurality of CPUs for the coherence granule being assigned to the unique cache state; and
in response to determining that the unique request issued on the interconnect bus became stale, issuing a snoop response on the interconnect bus to the snoop controller to convert the stale unique request to a read unique snoop response.

26. The method of claim 25, further comprising not retrying the unique request in response to determining that the unique request issued on the interconnect bus became stale.

27. The method of claim 25, wherein, in response to determining that a memory address of a memory write operation is not contained in its associated cache memory:
determining if the coherence granule is in a unique cache state; and
in response to determining the coherence granule is in a unique cache state:
not issuing the unique request for the coherence granule on the interconnect bus to request the unique cache state for the coherence granule in its associated cache memory; and
performing the memory write operation to its associated cache memory.

28. The method of claim 25, further comprising:
accessing its associated cache memory in response to the memory write operation;
determining if the memory address of the memory write operation is contained in its associated cache memory;
in response to determining that the memory address of the memory write operation is not contained in its associated cache memory, issue an upgrade unique request as the unique request for the coherence granule on the interconnect bus to request the unique cache state for the coherence granule in its associated cache memory.

29. The method of claim 28, further comprising, in response to determining that the memory address of the memory write operation is contained in its associated cache memory, issuing a read unique request for the unique request for the coherence granule on the interconnect bus to request a unique cache state for the coherence granule in its associated cache memory.

30. The method of claim 25, further comprising:
snooping the unique request on the interconnect bus for the coherence granule in response to the issued unique request issued by the master CPU; and
issuing a snoop response to the snoop controller on the interconnect bus indicating a willingness to provide data for the coherence granule from its associated cache memory over the interconnect bus to be snooped by a requesting CPU among the plurality of CPUs.

31. The method of claim 30, wherein, in response to the issued snoop response indicating the willingness to provide the data for the coherence granule, sending the data in the associated cache memory of the snooper CPU for the coherence granule on the interconnect bus.

32. The method of claim 25, further comprising:
snooping the unique request on the interconnect bus for the coherence granule in response to the issued unique request issued by the master CPU; and
issuing a snoop response to the snoop controller on the interconnect bus with data for the coherence granule from its associated cache memory over the interconnect bus to be snooped by at least one requesting CPU among the plurality of CPUs.
